(19) United States
(12) Patent Application Publication
(10) Pub. No.: US 2015/0012842 A1
(43) Pub. Date: Jan. 8, 2015

(54) COMMUNICATION WINDOW DISPLAY MANAGEMENT

(71) Applicant: Google Inc., Mountain View, CA (US)

(72) Inventors: Alexander Friedrich KUSCHER, San Francisco, CA (US); John Nicholas JITKOFF, Palo Alto, CA (US)

(21) Appl. No.: 13/934,162

(22) Filed: Jul. 2, 2013

(51) Int. Cl. H04L 29/06

(52) U.S. Cl. CPC H04L 65/403
USPC 715/753

(57) ABSTRACT

Methods for displaying communication windows are provided. In one aspect, a method includes providing, for display in a graphical user interface, a first window that includes a first communication session between a first sending user and a receiving user. The first window is displayed at a first location associated with a representation of the first sending user. The method also includes providing a second window that includes a second communication session between a second sending user and the receiving user for display at a second location associated with a representation of the second sending user. The second window is provided for display either adjacent to the first window, or the second window is provided for display in a stack with the first window such that visibility of the second window in the stack is limited to a portion of the second window. Systems and machine-readable media are also provided.

### BACKGROUND

1. Field

The present disclosure generally relates to the transmission of data over a network, and more particularly to the use of a computing device to display data communicated over a network.

2. Description of the Related Art

Real-time transmission of text-based messages from a sender to receiver over the Internet is commonly displayed on the receiver's computer within a graphical user interface “chat” window associated with the sender. Programs that commonly use this interface include online chat applications such as instant messengers, Internet Relay Chat (IRC), and talkers. One chat window may be displayed for each sender when the receiver is communicating with several senders, resulting in multiple chat windows. Multiple chat windows are commonly tiled across the display of the receiver's display or are stacked one on top of another such that the topmost chat window is visible and chat windows below the topmost chat window are not visible (“uniform stacking”).

In instances where chat windows are tiled, the receiver may lose some or all of the display area of the receiver's computer to chat windows for multiple senders that are tiled across the display area. Consequently, the receiver may not be able to interact with windows or content from other applications due to those windows or other content being covered by the tiled chat windows.

In instances where chat windows are uniformly stacked, the receiver cannot view messages from a sender other than the sender associated with the topmost chat window. Consequently, the receiver may not timely view or may even lose chat windows that are not the topmost chat window in the uniform stack.

### SUMMARY

According to certain embodiments of the present disclosure, a computer-implemented method for displaying communication windows in a graphical user interface is provided. The method includes providing, for display in a graphical user interface, a first window that includes a first communication session between a first sending user and a receiving user. The first window is displayed at a first location associated with a representation of the first sending user. The method also includes providing a second window that includes a second communication session between a second sending user and the receiving user for display at a second location associated with a representation of the second sending user. The second window is provided for display either adjacent to the first window such that substantially all of the first window and the second window are visible, or the second window is provided for display in a stack with the first window such that visibility of the second window in the stack is limited to a portion of the second window, and substantially all of the first window is visible in the stack.

According to certain embodiments of the present disclosure, a system for displaying communication windows in a graphical user interface is provided. The system includes a memory that includes instructions, and one or more processors. The one or more processors is configured to execute the instructions to provide, for display in a graphical user interface, a first window that includes a first communication session between a first sending user and a receiving user. The first window is displayed at a first location associated with a representation of the first sending user. The one or more processors is also configured to execute the instructions to provide a second window that includes a second communication session between a second sending user and the receiving user for display at a second location associated with a representation of the second sending user. The second window is provided for display either adjacent to the first window such that substantially all of the first window and the second window are visible and the first window and the second window share at least a portion of one window border, or the second window is provided for display in a stack with the first window such that visibility of the second window in the stack is limited to a portion of the second window, and substantially all of the first window is visible in the stack.

According to certain embodiments of the present disclosure, a machine-readable storage medium includes machine-readable instructions for causing a processor to execute a method for displaying communication windows in a graphical user interface is provided. The method includes providing, for display in a graphical user interface, a first window that includes a first communication session between a first sending user and a receiving user. The first window is displayed at a first location associated with a representation of the first sending user. The method also includes providing a second window that includes a second communication session between a second sending user and the receiving user for display at a second location associated with a representation of the second sending user. The second window is provided for display either adjacent to the first window such that substantially all of the first window and the second window are visible, or the second window is provided for display in a stack with the first window such that visibility of the second window in the stack is limited to a portion of the second window, and substantially all of the first window is visible in the stack. The first window is a topmost window in the stack and displayed in a foreground of a plurality windows in the stack. A display area of each of the remaining of the plurality of windows is at least partially occluded by one or more other windows from among the plurality of windows in the stack.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for displaying communication windows in a graphical user interface.

FIG. 2 is a block diagram illustrating an example client and server from the architecture of FIG. 1 according to certain aspects of the disclosure.

FIG. 3 illustrates an example process for displaying communication windows in a graphical user interface using an example client of FIG. 2.

FIGS. 4A-4C are example illustrations associated with the example process of FIG. 3.

FIG. 5 is a block diagram illustrating an example computer system with which the client and server of FIG. 2 can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

The disclosed system displays chat windows in a display area on a computer desktop by non-uniformly stacking (e.g., fanning) or adjacently displaying the chat windows. The chat windows are organized with respect to an associated content item or icon, such as an icon representing the remote user (the “sender”) with whom the user of the computer desktop (the “recipient”) is chatting.

The organization of chat windows in a graphical user interface (GUI) becomes particularly important as the number of chat windows increases. In certain display layouts, it is desirable to collect and fan windows in a manner that places each window adjacent to an icon or button for related content. By way of example, if the recipient's contacts are represented in the GUI by distinct icons in a launcher or taskbar, then chat windows for each of the contacts may be displayed adjacent to the corresponding contact's icon.

In certain aspects, where only two chat windows are open or otherwise displayed, the two chat windows may be tiled such that a display area of each of the two chat windows is entirely visible to the user. If more than two chat windows are displayed, each of the chat windows may be overlapped in a non-uniform stack, such that one or more of the chat windows is occluded by one or more other chat windows while one of the chat windows is not occluded by any of the other chat windows. In such a non-uniform stack, none of the windows will be entirely occluded. By way of example, if N>2 total windows were to be displayed, N−1 windows may be occluded, with a display area of at least 1 window being fully visible to the user.

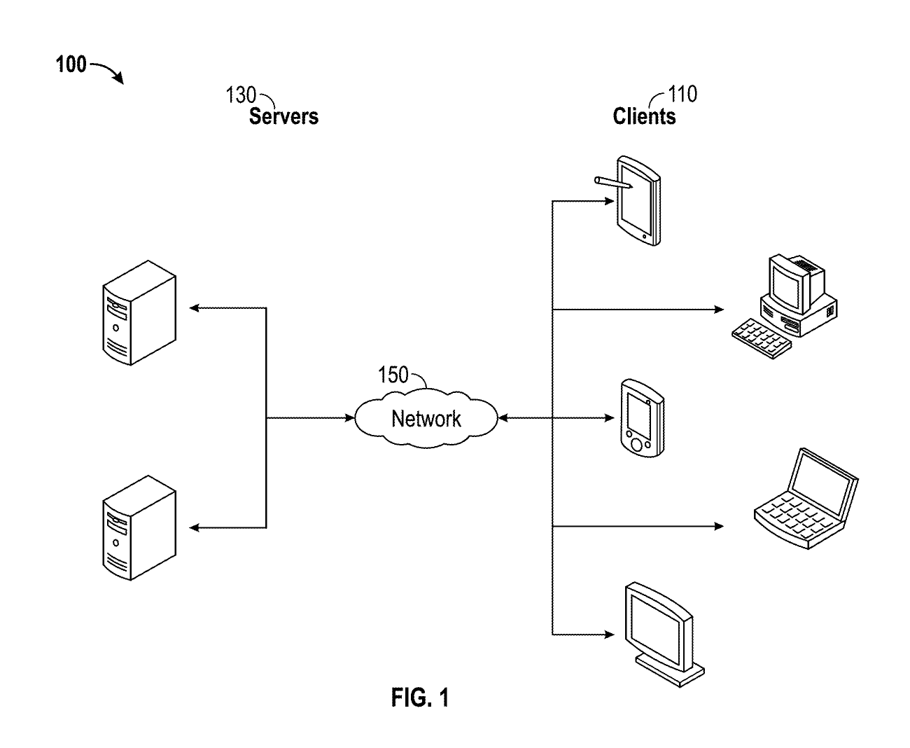

FIG. 1 illustrates an example architecture 100 for switching between tabbed windows. The architecture 100 includes servers 130 and clients 110 connected over a network 150.

Each of the clients 110 is configured to download, install, and run a client application for managing communication sessions between multiple senders and a recipient and displaying chat windows for the communication sessions as disclosed herein. The client application can be, for example, an online chat application such as an instant messenger, IRC, or talker. The application is configured to run on clients 110 that are mobile or non-mobile. The clients 110 can be, for example, desktop computers, laptop computers, mobile devices (e.g., a smartphone, tablet computer, or PDA), set top boxes (e.g., for a television), video game consoles, or any other devices having appropriate processor, memory, touch input, and communications capabilities. In certain aspects, certain advantages of the application, such as efficiently using a display area to display multiple chat windows, are most salient on clients 110 that are used for multitasking, such as desktop computers and laptop computers.

The client application, once installed on a client 110, is configured to send and receive messages for multiple communication sessions between senders and a recipient (e.g., users of clients 110). The messages and communication sessions are managed by a server application hosted on a server 130, such that a sender at a first client 110 sends a message to a recipient at a second client 110 via the server application on the server 130. The servers 130 can be any device having an appropriate processor, memory, and communications capability for hosting the server application. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

The client application provides each communication session for display in a separate chat window of a graphical user interface on a client 110. Each of the chat windows is associated with a representation of the sender (e.g., the sender's icon) in the graphical user interface. If two chat windows are currently open in the client application, the two chat windows are displayed adjacent to one another, such that they share, for example, a common border. If more than two chat windows are currently open in the client application, the chat windows are stacked in a non-uniform configuration, such that all of a topmost chat window in the stack is displayed, and portions of the remaining chat windows in the stack below the topmost chat window are displayed. The chat windows in the stack can be arranged, for example, chronologically such that a chat window having received a communication is moved to the top of the stack.

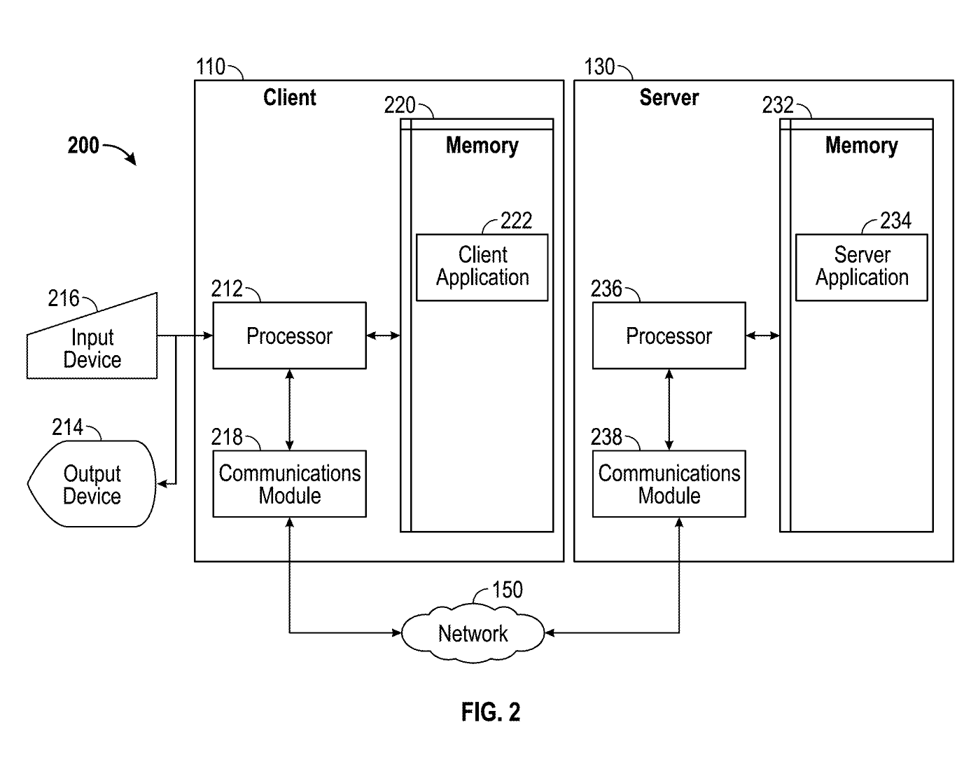

FIG. 2 is a block diagram illustrating an example server 130 and client 110 in the architecture 100 of FIG. 1 according to certain aspects of the disclosure. The client 110 and the server 130 are connected over the network 150 via respective communications modules 218 and 238. The communications modules 218 and 238 are configured to interface with the network 150 to send and receive information, such as data, requests, responses, and commands to other devices on the network. The communications modules 218 and 238 can be, for example, modems or Ethernet cards.

The client 110 includes a processor 212, the communications module 218, and a memory 220 that includes a client application 222 for displaying communication sessions between users. The client 110 also includes an input device 216, such as a keyboard or mouse, for receiving a new message for a communication session by a user of the client 110, and an output device 214, such as a display, for displaying the client application 222 and its communication sessions. The client application 222 can be, for example, an online chat application such as an instant messenger, IRC, or talker.

The processor 212 of the client 110 is configured to execute instructions, such as instructions physically coded into the processor 212, instructions received from software in memory 240, or a combination of both, to display communication windows in a graphical user interface. Each communication window corresponds to a communication session between a recipient (e.g., the user of the client 110) and a sender (e.g., another user). A server application 234 in a memory 232 of a server 130 hosts the communication session and sends messages to/from respective client applications 222 on different clients 110. Specifically, when a message for a communication session is received over the network 150 by the recipient or the sender, the message is provided by the processor 236 of the server 130 using the server's communications module 238 to an appropriate client 110 for display.

Turning back to the client 110, the processor 212 of the client 110 executes instructions from the client application 222 causing the processor 212 to provide, for display in a graphical user interface (e.g., on output device 214), a first window (e.g., a chat window) including a first communication session between a first sending user and a receiving user. The first window is displayed at a first location associated with a representation of the first sending user, such as an icon of the first sending user.

The processor 212 of the client 110 also executes instructions from the client application 222 causing the processor 212 to provide a second window including a second communication session between a second sending user and the receiving user. The second window is provided for display at a second location associated with a representation (e.g., icon, avatar, or name) of the second sending user. When the representation of the first sending user and the representation of the second sending user includes icons or avatars, the icons or avatars can be provided for display along a single axis. The single axis can be along, for example, a launcher, taskbar, or toolbar.

The second window is provided for display either adjacent to the first window such that substantially all of the first window and the second window are visible, or the second window is provided for display in a stack with the first window such that visibility of the second window in the stack is limited to a portion of the second window, and substantially all of the first window is visible in the stack.

When the second window is provided for display in the stack with the first window such that visibility of the second window in the stack is limited to a portion of the second window, and substantially all of the first window is visible in the stack, the first window is a topmost window in the stack and displayed in a foreground of a plurality windows in the stack. A display area of each of the remaining windows in the stack is at least partially occluded by one or more other windows in the stack. For example, the stack may be tiered such that the topmost window is completely visible, while at least one of the left, right, bottom, or top edges of each window below the topmost window are visible.

Furthermore, when the second window is provided for display in the stack with the first window, the processor 212 may be configured to receive an input (e.g., from input device 216) from the receiving user indicating a selection of one of the remaining windows in the stack, and arrange the windows in the stack such that the selected window is displayed in the foreground of the windows in the stack and the display area of each of the remaining windows in the stack is at least partially occluded by the selected window. The processor 212 may yet further be configured to receive a communication (e.g., a text-based message) from either the first sending user or the receiving user in the first communication session and receive a communication from either the second sending user or the receiving user in the second communication session, and the first window will be displayed above the second window in the stack when the communication in the second communication session is received prior to the communication in the first communication session. For example, a chat window corresponding to the most recently received or sent message in a communication session will be displayed on top of other chat windows in the stack.

When the second window is provided for display adjacent to the first window such that substantially all of the first window and the second window are visible, the processor 212 is instructed by the client application 222 to provide for display no additional communication sessions adjacent to the first communication session (e.g., of the first window) and the second communication session (e.g., of the second window). For example, two chat windows are displayed adjacent to one another when no additional chat windows are open in the client application 222. The two chat windows can share at least a portion of one window border, so that, for example, the right border of the first chat window is next to and parallel with the left border of the second chat window.

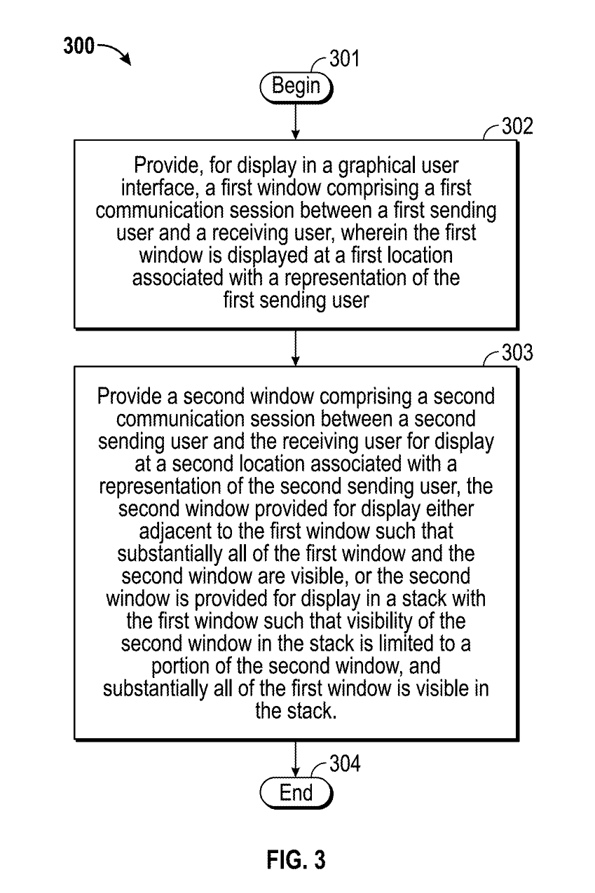

FIG. 3 illustrates an example process 300 for displaying communication windows in a graphical user interface using the example client 110 of FIG. 2. While FIG. 3 is described with reference to FIG. 2, it should be noted that the process steps of FIG. 3 may be performed by other systems. The process 300 begins by proceeding from beginning step 301 when a client application 222 is opened on the client 110 and at least two communication sessions in the client application 222 are opened to step 302 when a first window including a first communication session between a first sending user and a receiving user is provided for display in a graphical user interface. The first window is displayed at a first location associated with a representation of the first sending user. Next, in step 303, a second window including a second communication session between a second sending user and the receiving user is provided for display in the graphical user interface at a second location associated with a representation of the second sending user. The second window is provided for display either adjacent to the first window (e.g., in instances where only two windows are open in the client application 222) such that substantially all of the first window and the second window are visible, or the second window is provided for display in a stack with the first window (e.g., in instances where more than two windows are open in the client application 222) such that visibility of the second window in the stack is limited to a portion of the second window, and substantially all of the first window is visible in the stack. The process 300 ends in step 304.

FIG. 3 set forth an example process 300 for displaying communication windows in a graphical user interface using the example client 110 of FIG. 2. An example will now be described using the example process 300 of FIG. 3, a client 110 that is a desktop computer, and two to three communication sessions opened in a client application 222 that is an instant messenger.

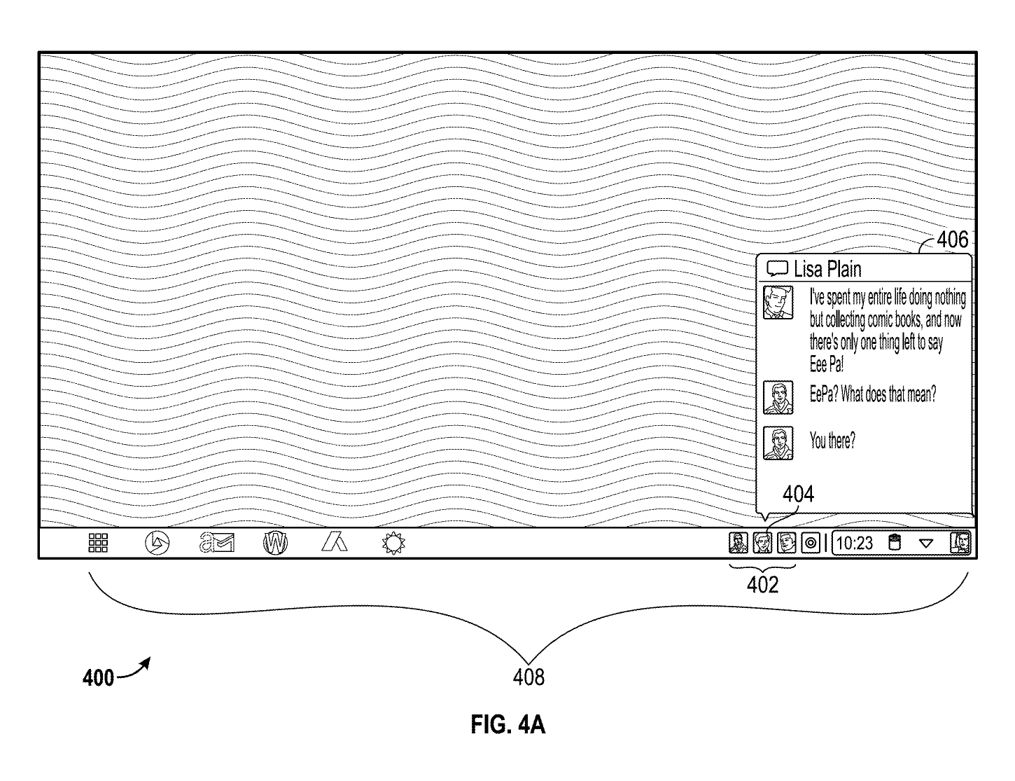

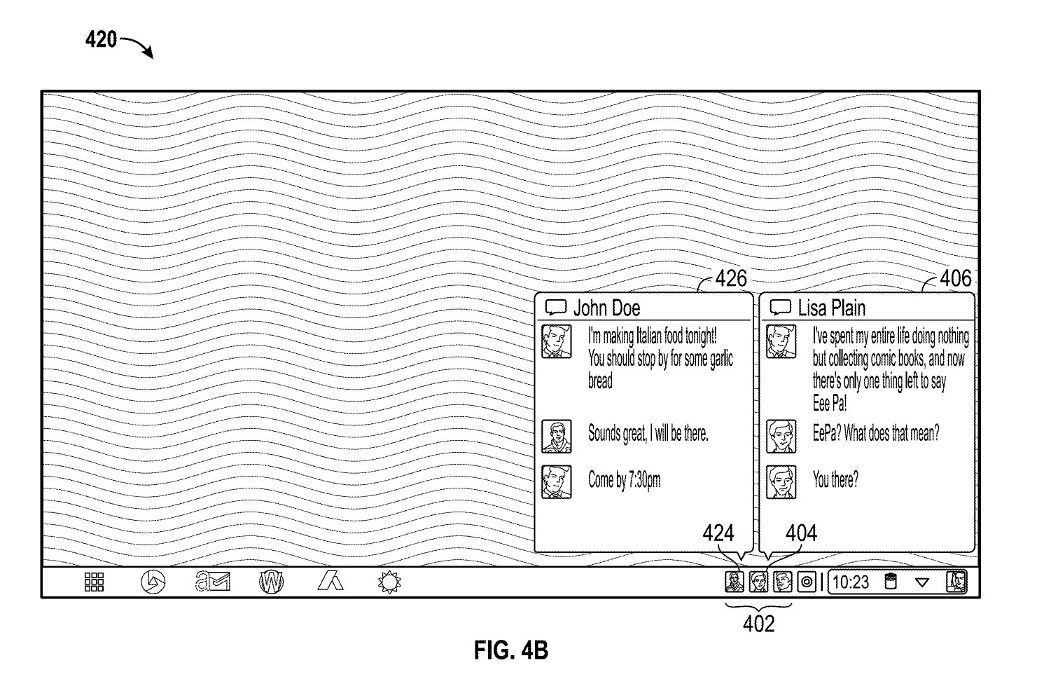

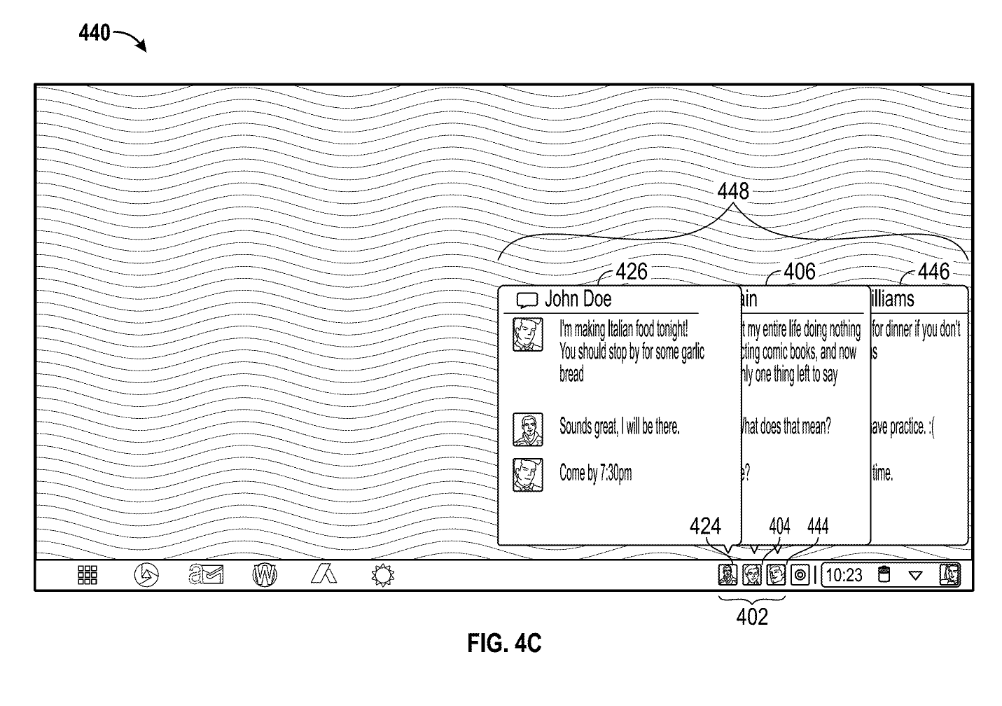

The process 300 begins by proceeding from beginning step 301 when the instant messenger 222 is opened by a local user on the desktop computer 110 and at least two chat sessions in the instant messenger 222 are initiated by the user. In step 302, a first chat window for a first chat session between a first remote user and a local user is provided for display in a graphical user interface as provided in the example illustration 400 of FIG. 4A. The first chat window 406 is displayed along a taskbar 408 that includes three icons 402 representing the different remote users (e.g., contacts) with whom the local user is connected to in the instant messenger 222. Specifically, the first chat window 406 is displayed pointing to the icon 404 of the first remote user. Next, in step 303, and as provided in the example illustration 420 of FIG. 4B, a second chat window 426 for a second chat session between a second remote user and the local user is provided for display in the graphical user interface at a second location pointing to the icon 424 of the second remote user among the three icons 402. As only two chat windows 406 and 426 are open in the instant messenger 222, the second chat window 426 is provided for display adjacent to the first chat window 406 such that the entire first chat window 406 and the second chat window 426 are visible. If, however, a third chat window 446 is also open (e.g., and displayed as pointing to a third sending user's icon 444), as provided in the example illustration 440 of FIG. 4C, each of the chat windows 406, 426, and 446 are provided for display in a stack 448 such that the most recently active chat window, the second chat window 426, is placed at the top of the stack 448 and entirely visible. The older first and third chat windows 406 and 446 are below the topmost window 426 in the stack 448 such that a portion of the older first and third chat windows 406 and 446 are visible in the stack 448. The process 300 ends in step 304.

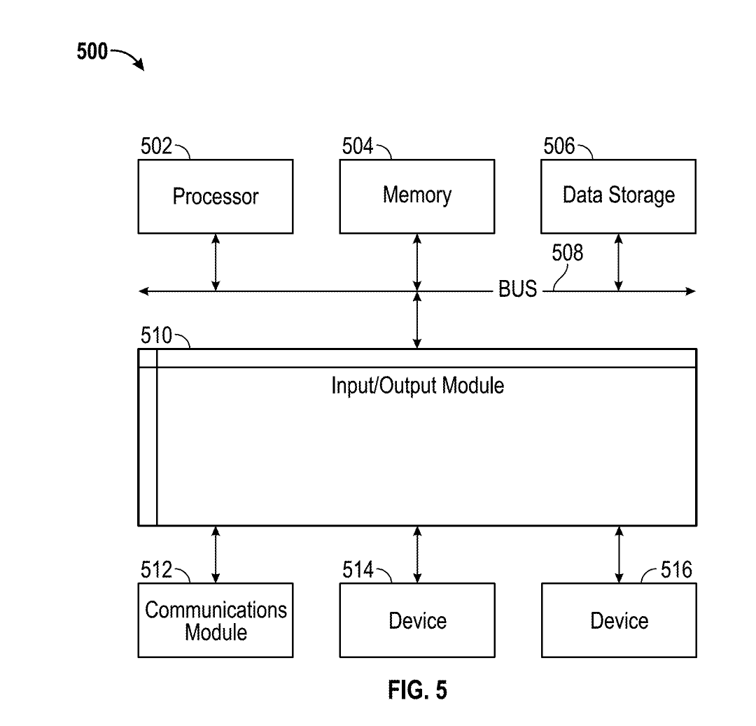

FIG. 5 is a block diagram illustrating an example computer system 500 with which the client 110 and server 130 of FIG. 2 can be implemented. In certain aspects, the computer system 500 may be implemented using hardware or a combination of software and hardware, either in a dedicated server, or integrated into another entity, or distributed across multiple entities.

Computer system 500 (e.g., client 110 and server 130) includes a bus 508 or other communication mechanism for communicating information, and a processor 502 (e.g., processor 212 and 236) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 220 and 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Example input/output modules 510 include data ports such as USB ports. The input/output module 510 is configured to connect to a communications module 512. Example communications modules 512 (e.g., communications module 218 and 238) include networking interface cards, such as Ethernet cards and moderns. In certain aspects, the input/output module 510 is configured to connect to a plurality of devices, such as an input device 514 (e.g., touch interface device 216) and/or an output device 516 (e.g., touch interface device 216). Example input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 516 include display devices, such as a LED (light emitting diode), CRT (cathode ray tube), or LCD (liquid crystal display) screen, for displaying information to the user.

According to one aspect of the present disclosure, the client 110 and server 130 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a PAN, a LAN, a CAN, a MAN, a WAN, a BBN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 502 for execution. Such a medium may take many forms, including, but not limited to, non-volatile media, volatile media, and transmission media. Non-volatile media include, for example, optical disks, magnetic disks, or flash memory, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

These and other implementations are within the scope of the following claims.

1. A computer-implemented method for displaying communication windows in a graphical user interface, the method comprising:
providing, for display in a graphical user interface and by a client application for managing communication sessions between at least one sending user and a receiver user, a first communication window comprising a first communication session between a first sending user and the receiving user, wherein the first communication session comprises a display of a communication of the first sending user and a communication of the receiving user, and the first window is displayed by the client application at a first location associated with a representation of the first sending user; and
providing a second communication window comprising a second communication session between a second sending user and the receiving user for display by the client application at a second location associated with a representation of the second sending user, wherein the second communication session comprises a display of a communication of the second sending user and another communication of the receiving user;
wherein, when at least two communication windows are displayed by the client application, the second communication window is provided and positioned for display by the client application either adjacent to the first communication window such that at least a portion of the first communication window and the second communication window are visible and the first communication window and the second communication window share at least a portion of one window border, or the second communication window is provided and positioned for display by the client application in a stack with the first communication window such that visibility of the second communication window in the stack is limited to a portion of the second communication window, and at least a portion of the first communication window is visible in the stack.

2. The computer-implemented method of claim 1, wherein the first communication window is a topmost window in the stack and displayed in a foreground of a plurality of communication windows in the stack, and wherein a display area of each of the remaining of the plurality of communication windows is at least partially occluded by one or more other windows from among the plurality of communication windows in the stack.

3. The computer-implemented method of claim 2, the method further comprising:
receiving an input from the receiving user indicating a selection of one of the remaining of the plurality of communication windows; and
arranging the plurality of communication windows in the stack such that the selected one of the remaining of the plurality of communication windows is displayed in the foreground of the plurality of communication windows,
wherein the display area of each of the plurality of communication windows, except the selected one of the remaining of the plurality of communication windows, is at least partially occluded by the one or more other windows from among the plurality of communication windows in the stack.

4. The computer-implemented method of claim 1, wherein, when the second communication window is provided for display in the stack with the first communication window such that visibility of the second communication window in the stack is limited to the portion of the second communication window, and at least a portion of the first communication window is visible in the stack, the method further comprises:
receiving a communication from either the first sending user or the receiving user in the first communication session; and
receiving a communication from either the second sending user or the receiving user in the first communication session,
wherein the communication in the second communication session is received prior to the communication in the first communication session.

5. The computer-implemented method of claim 4, wherein the received communication is a text-based message.

6. The computer-implemented method of claim 1,
wherein the client application comprises an online chat application, and
wherein, when the second communication window is provided for display adjacent to the first communication window such that at least a portion of the first communication window and the second communication window are visible, the online chat application is providing for display no additional communication sessions other than the first communication session and the second communication session.

7. (canceled)

8. The computer-implemented method of claim 1 wherein the representation of the first sending user and the representation of the second sending user comprise icons of the first sending user and the second sending user.

9. The computer-implemented method of claim 1, wherein the icons are provided for display along a single axis.

10. The computer-implemented method of claim 1, wherein the single axis comprises at least one of a launcher or taskbar.

11. A system for displaying communication windows in a graphical user interface, the system comprising:
a memory comprising instructions; and
one or more processors configured to execute the instructions to:
provide, for display in a graphical user interface and by a client application for managing communication sessions between at least one sending user and a receiver user, a first communication window comprising a first communication session between a first sending user and the receiving user, wherein the first communication session comprises a display of a communication of the first sending user and a communication of the receiving user, and the first window communication is displayed by the client application at a first location associated with a representation of the first sending user; and
provide a second communication window comprising a second communication session between a second sending user and the receiving user for display by the client application at a second location associated with a representation of the second sending user, wherein the second communication session comprises a display of a communication of the second sending user and another communication of the receiving user;
wherein, when at least two communication windows are displayed by the client application, the second communication window is provided and positioned for display by the client application either adjacent to the first communication window such at least a portion of the first communication window and the second communication window are visible and the first communication window and the second communication window share at least a portion of one window border, or the second communication window is provided and positioned for display by the client application in a stack with the first communication window such that visibility of the second communication window in the stack is limited to a portion of the second communication window, and at least a portion of the first communication window is visible in the stack.

12. The system of claim 11, wherein the first communication window is a topmost window in the stack and displayed in a foreground of a plurality of communication windows in the stack, and wherein a display area of each of the remaining of the plurality of communication windows is at least partially occluded by one or more other windows from among the plurality of communication windows in the stack.

13. The system of claim 12, the method further comprising:
receiving an input from the receiving user indicating a selection of one of the remaining of the plurality of communication windows; and
arranging the plurality of communication windows in the stack such that the selected one of the remaining of the plurality of communication windows is displayed in the foreground of the plurality of communication windows,
wherein the display area of each of the plurality of communication windows, except the selected one of the remaining of the plurality of communication windows, is at least partially occluded by the one or more other windows from among the plurality of communication windows in the stack.

14. The system of claim 11, wherein, when the second communication window is provided for display in the stack with the first communication window such that visibility of the second communication window in the stack is limited to the portion of the second communication window, and at least a portion of the first communication window is visible in the stack, the method further comprises:
receiving a communication from either the first sending user or the receiving user in the first communication session; and
receiving a communication from either the second sending user or the receiving user in the first communication session,
wherein the communication in the second communication session is received prior to the communication in the first communication session.

15. The system of claim 14, wherein the received communication is a text-based message.

16. The system of claim 11,
wherein the client application comprises an online chat application, and
wherein, when the second communication window is provided for display adjacent to the first communication window such that at least a portion of the first communication window and the second communication window are visible, the online chat application is providing for display no additional communication sessions other than the first communication session and the second communication session.

17. The system of claim 11, wherein the representation of the first sending user and the representation of the second sending user comprise icons of the first sending user and the second sending user.

18. The system of claim 11, wherein the icons are provided for display along a single axis.

19. The system of claim 11, wherein the single axis comprises at least one of a launcher or taskbar.

20. A non-transitory machine-readable storage medium comprising machine-readable instructions for causing a processor to execute a method for displaying communication windows in a graphical user interface, the method comprising:
providing, for display in a graphical user interface and by a client application for managing communication sessions between at least one sending user and a receiver user, a first communication window comprising a first communication session between a first sending user and a receiving user, wherein the first communication session comprises a display of a communication of the first sending user and a communication of the receiving user, and the first communication window is displayed by the client application at a first location associated with a representation of the first sending user; and
providing a second communication window comprising a second communication session between a second sending user and the receiving user for display by the client application at a second location associated with a representation of the second sending user, wherein the second communication session comprises a display of a communication of the second sending user and another communication of the receiving user;
wherein, when at least two communication windows are displayed by the client application, the second communication window is provided and positioned for display by the client application either adjacent to the first communication window such that at least a portion of the first communication window and the second communication window are visible and the first communication window and the second communication window share at least a portion of one window border, or the second communication window is provided and positioned for display by the client application in a stack with the first communication window such that visibility of the second communication window in the stack is limited to a portion of the second window, and at least a portion of the first window is visible in the stack, and
wherein the first communication window is a topmost window in the stack and displayed in a foreground of a plurality of communication windows in the stack, and wherein a display area of each of the remaining of the plurality of communication windows is at least partially occluded by one or more other windows from among the plurality of communication windows in the stack.
